(19) United States
(12) Patent Application Publication
(10) Pub. No.: US 2002/0085879 A1
(43) Pub. Date: Jul. 4, 2002

(54) Modifiable backbone

(76) Inventors: Russell Nelson, Coppell, TX (US); Jim Kindley, Dallas, TX (US)

Correspondence Address: Daniel J. Chalker, Gardere Wynne Sewell, LLP, 3000 Thanksgiving Tower, Suite 3000, 1601 Elm Street, Dallas, TX, 75201-4767, US

(21) Appl. No.: 09/874,462

(22) Filed: Jun. 2, 2001

Related U.S. Application Data
(60) Provisional application No. 60/209,080, filed on Jun. 2, 2000.

(51) Int. Cl. F16B 1/00

(52) U.S. Cl. 403/286

(57) ABSTRACT

The present invention provides a modifiable backbone having a pair of removable swing arms and a backbone. In one embodiment, the backbone has a bottom, two sides extending outward from the bottom to form a channel, a first top covering a first section of the channel and a second top covering a second section of the channel. The first covered channel section and second covered channel section are sized and spaced apart so that each covered channel can receive both removable swing arms. In another embodiment, the backbone comprises a substantially rectangular block having a cutout disposed between a first section and a second section of the block. In addition, the first and second sections have one or more longitudinal openings to receive the removable swing arms.

### RELATED APPLICATIONS

This application claims priority based on a provisional patent application entitled Modifiable Backbone Apparatus and Attachment Method, serial No. 60/209,080 filed on Jun. 2, 2000.

### FIELD OF THE INVENTION

The present invention relates in general to attachment devices and more particularly, to a modifiable backbone.

### BACKGROUND OF THE INVENTION

Attachment devices typically are either very simple with little or no adjustability, or are very complex with a great deal of adjustability. In the first case, these attachment devices are inexpensive to produce, but may not provide the end user with the desired flexibility. In the latter case, these devices are more expensive and more prone to failure. Moreover, they may be hard for the end user to adjust them as desired.

Accordingly, there is a need for a relatively simple attachment device that can be combined and adjusted in various manners in order to carefully and accurately control the height and angle of the attached device.

### SUMMARY OF THE INVENTION

The present invention provides a relatively simple attachment device that can be combined and adjusted in various manners in order to carefully and accurately control the height and angle of the attached device. For example, the present invention can be used to attach a portable fountain to a garden container.

More Specifically, the present invention provides a modifiable backbone having a pair of removable swing arms and a backbone. The backbone has a bottom, two sides extending outward from the bottom to form a channel, a first top covering a first section of the channel and a second top covering a second section of the channel. The first covered channel section and second covered channel section are sized and spaced apart so that each covered channel can receive both removable swing arms.

The present invention also provides a modifiable backbone having a pair of removable swing arms and a backbone comprising a substantially rectangular block. The backbone has a cutout disposed between a first section and a second section of the block. In addition, the first and second sections have one or more longitudinal openings to receive the removable swing arms.

The swing arms are used to hook over the edge of a typical garden planter, container or other type of wall. The section in which the swing arms are inserted determines the mounting height of the device attached to the present invention. Adjusting the angle between the swing arms modifies the angle of the device attached to the present invention. The swing arms are independently adjustable so that edge being hook to can be linear, circular, angled, irregularly shaped or anything in between.

### BRIEF DESCRIPTION OF THE DRAWINGS

For a more complete understanding of the features and advantages of the present invention, reference is now made to the detailed description of the invention along with the accompanying figures in which corresponding numerals in the different figures refer to corresponding parts and in which:

FIGS. 1A, 1B and 1C are front, top and side views, respectively, of a modifiable backbone in accordance with one embodiment of the present invention;

FIGS. 2A, 2B and 2C are front, top and side views, respectively, of a backbone in accordance with one embodiment of the present invention;

FIGS. 3A, 3B and 3C are front, top and side views, respectively, of a backbone in accordance with another embodiment of the present invention;

FIGS. 4A, 4B and 4C are front, top and side views, respectively, of a backbone in accordance with another embodiment of the present invention;

FIGS. 5A and 5B are perspective views of a backbone before and after the formation of a cutout in accordance with another embodiment of the present invention;

FIG. 6 is a perspective view of a backbone in accordance with another embodiment of the present invention;

FIGS. 7A, 7B, 7C and 7D are front perspective, back, side and top views, respectively, of a container fountain having a modifiable backbone in accordance with one embodiment of the present invention;

FIG. 8A is an exploded side view of a container, a container fountain and a modifiable backbone in accordance with the present invention showing height adjustability; and

FIG. 8B is a top view of a portion of a container, a container fountain and a modifiable backbone in accordance with the present invention showing angle adjustability.

### DETAILED DESCRIPTION OF THE INVENTION

It should be understood that the principles and applications disclosed herein can be applied to a wide range of attachment devices. The present invention provides an apparatus that can be combined and adjusted in various manners in order to carefully and accurately control the height and angle of the attached device. For purposes of explanation and illustration, the present invention is hereafter described in reference to a container fountain. However, the same approach may be used in a number of circumstances.

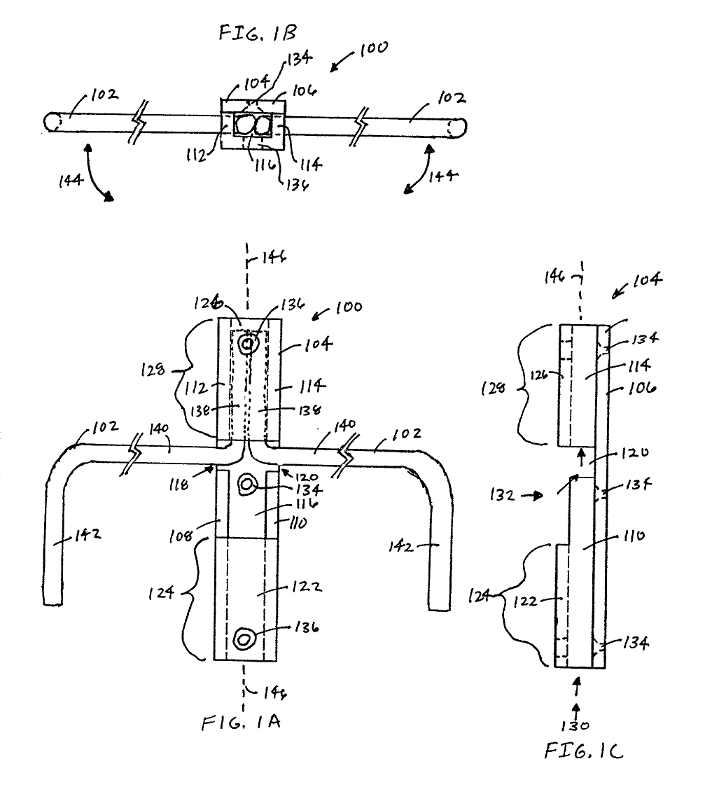

FIGS. 1A, 1B and 1C are front, top and side views, respectively, of a modifiable backbone 100 in accordance with one embodiment of the present invention. The modifiable backbone 100 includes a pair of removable swing arms 102 and a backbone 104. The backbone 104 has a bottom 106 and sides 108, 110, 112 and 114 extending outward from the bottom 106 to form a channel 116. Sides 108 and 112 can be considered as one side with a gap 118 between. Similarly, sides 110 and 114 can be considered as another side with a gap 120 between. Gaps 118 and 120 allow both swing arms 102 to rotate to a position substantially parallel to the bottom 106 of the backbone 104 as illustrated in FIG. 1B. A first top 122 covers a first section 124 of the channel 116. Similarly, a second top 126 covers a second section 128 of the channel 116. The first covered channel section 124 and second covered channel section 128 are sized and spaced apart so that each covered channel 124 and 128 can receive both removable swing arms 102 as indicated by arrows 130 and 132 in FIG. 1C. Note that the removable swing arms 102 are not shown in FIG. 1C to reduce the complexity of the figure.

As will be illustrated in later figures, the modifiable backbone 100 can be attached to a device by many methods known to those skilled in the art. For example, FIGS. 1A, 1B and 1C illustrate the use of mounting holes 134 that extend through the bottom 106 of the backbone 104. The mounting holes 134 are dimensioned such that the head of the screws, nuts, bolts or other types of fasteners will be substantially flush with the top surface of the bottom 106 and not interfere with the insertion of the swing arms 102 into the channel 116. A glue or other adhesive applied to the back of the backbone 104 may be used either in lieu of or in combination with the screws, nuts, bolts or other types of fasteners. Whenever the mounting holes 134 are located under the first top 122 or second top 124, an access hole 136 is extended through the first top 122 or second top 124 above the mounting holes 134 to allow installation or removal of the screws, nuts, bolts or other types of fasteners.

Each swing arm has a first arm section 138, a second arm section 140 and a third arm section 142. The first arm section 138 is inserted into the first covered channel section 124 or the second covered channel section 128. The second arm section 140 is disposed between the first arm section 138 and the third arm section 142. The second arm section 140 extends away from the backbone 104 when the first arm section 138 is inserted into the first covered channel section 124 or the second covered channel section 128. The third arm section 142 extends away from and approximately parallel to the first arm section 138. As shown by arrows 144 in FIG. 1B, the removable swing arms 102 are free to rotate about the longitudinal axis 146 of the backbone 104. The removable swing arms 102 may be a semi-rigid shaped wire or rod that allows the user to adjust the shape of the second or third arm section 140 and 142. The size and length of the removable swing arms 102 will vary according to the size and weight of the attached device.

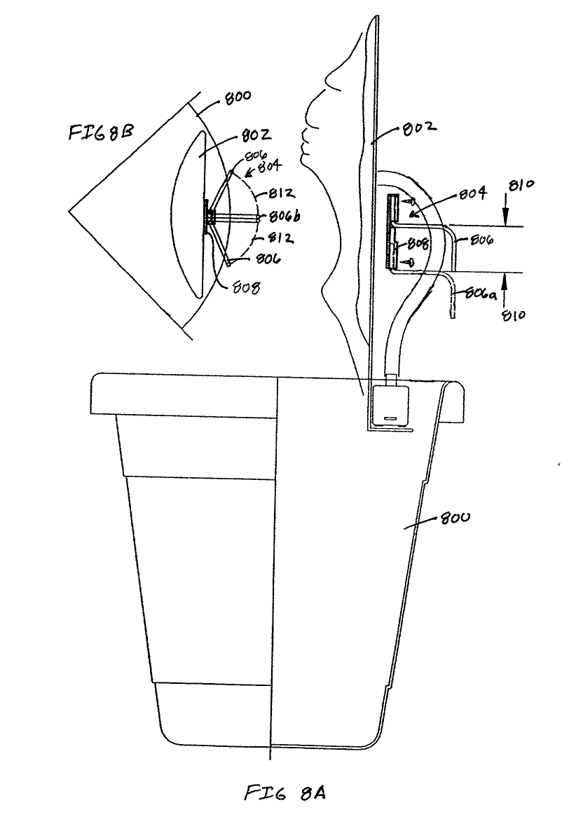

The removable swing arms 102 are used to hook over the edge of a typical garden planter, container or other type of wall (See FIGS. 8A and 8B). The section 124 or 128 in which the swing arms 102 are inserted determines the mounting height of the device attached to the present invention. Adjusting the angle between the removable swing arms 102 modifies the angle of the device attached to the present invention. The removable swing arms 102 are independently adjustable so that edge being hook to can be linear, circular, angled, irregularly shaped or anything in between.

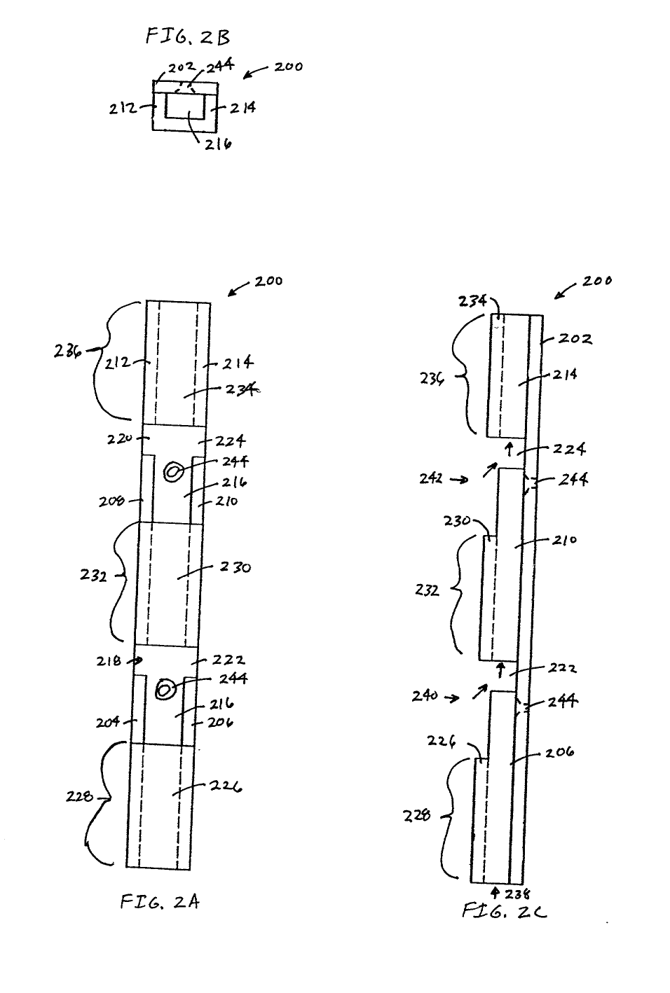

Now referring to FIGS. 2A, 2B and 2C, front, top and side views, respectively, of a backbone 200 in accordance with one embodiment of the present invention are shown. Note that the removable swing arms 102 (FIGS. 1A and 1B) are not shown in FIGS. 2A, 2B and 2C to reduce the complexity of these figures. The backbone 200 has a bottom 202 and sides 204, 206, 208, 210, 212 and 214 extending outward from the bottom 202 to form a channel 216. Sides 204, 208 and 212 can be considered as one side with gaps 218 and 220 between them. Similarly, sides 206, 210 and 214 can be considered as another side with gaps 222 and 224 between them. A first top 226 covers a first section 228 of the channel 216. Similarly, a second top 230 covers a second section 232 of the channel 216, and a third top 234 covers a third section 236 of the channel 216. The first, second and third covered channel sections 228, 232 and 236 are sized and spaced apart so that each covered channel sections 228, 232 and 236 can receive both removable swing arms 102 (FIGS. 1A and 1B) as indicated by arrows 238, 240 and 242 in FIG. 2C. As previously described, mounting holes 244 extend through the bottom 202 of the backbone 200. Mounting holes 244 could also be positions under covered channels 228, 232 or 236. These figures also illustrate that any number of covered channel sections 228, 232 and 236 can be used to adjust the height of the modifiable backbone.

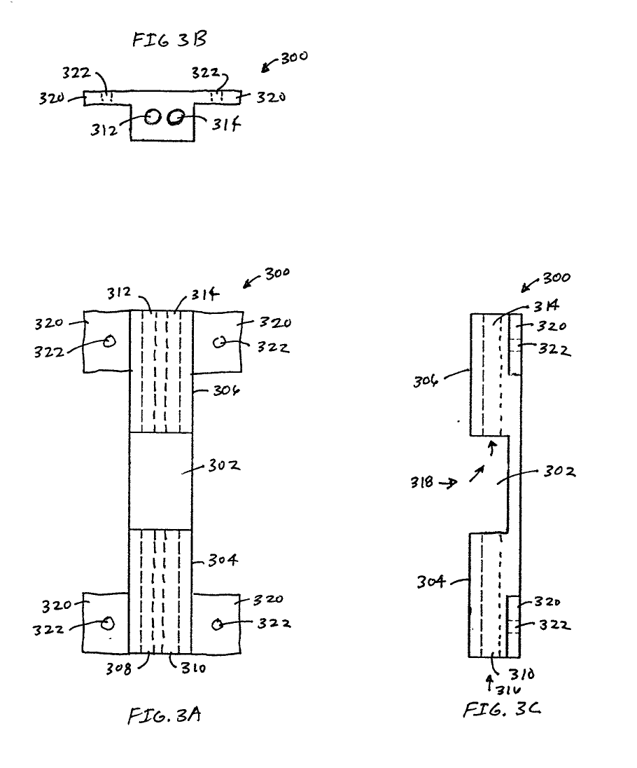

Referring now to FIGS. 3A, 3B and 3C, front, top and side views, respectively, of a backbone 300 in accordance with another embodiment of the present invention are shown. Note that the removable swing arms 102 (FIGS. 1A and 1B) are not shown in FIGS. 3A, 3B and 3C to reduce the complexity of these figures. The backbone 300 is a substantially rectangular block having cutout 302 disposed between a first section 304 and a second section 306 of the block. The first section 304 has two parallel longitudinal openings, holes or bores 308 and 310. Although the longitudinal openings 308, 310, 312 and 314 are shown to extend through the first and second sections 304 and 306, this is not required. The longitudinal openings 308, 310, 312 and 314 only have to extend far enough to allow for proper insertion of the removable swing arms 102 (FIGS. 1A and 1B). Moreover, a single longitudinal opening through the first and second sections 304 and 306 can be used instead of longitudinal openings 308, 310, 312 and 314. The first and second sections 304 and 306 are sized and spaced apart so that longitudinal openings 308, 310, 312 and 314 can receive the removable swing arms 102 (FIGS. 1A and 1B) as indicated by arrows 316 and 318 in FIG. 2C. Backbone 300 also has mounting tabs 320 that extend out from the four bottom comers of the backbone 300. Mounting holes 322 extend through the mounting tabs 320.

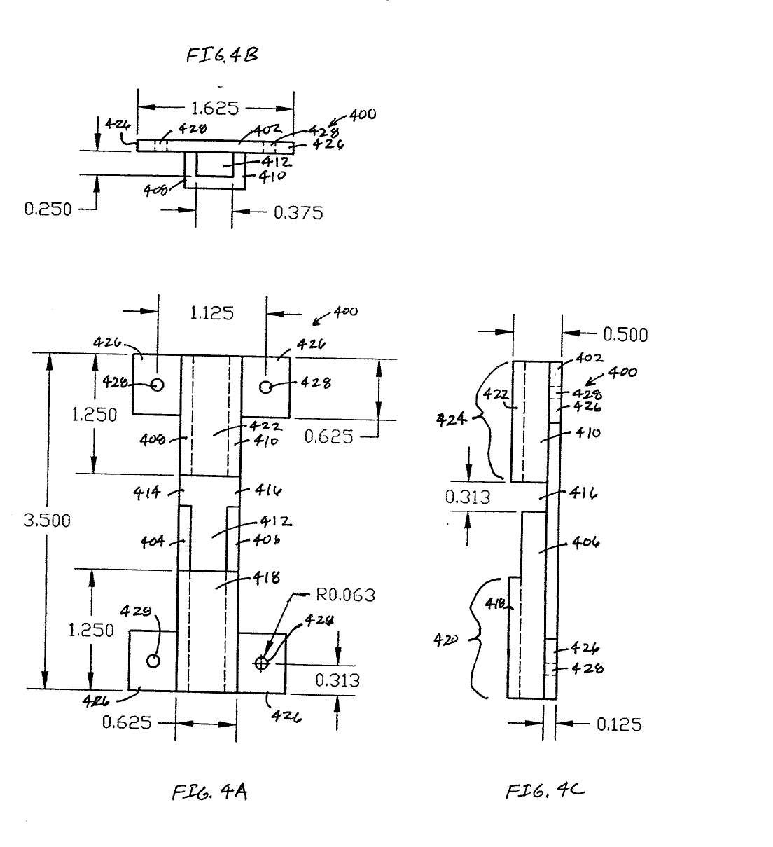

Now referring to FIGS. 4A, 4B and 4C, front, top and side views, respectively, of a backbone 400 in accordance with another embodiment of the present invention are shown. Note that the removable swing arms 102 (FIGS. 1A and 1B) are not shown in FIGS. 4A, 4B and 4C to reduce the complexity of these figures. In addition, dimensions (inches) and dimension lines are shown to provide an example of one implementation of the present invention. The backbone 400 has a bottom 402 and sides 404, 406, 408 and 410 extending outward from the bottom 402 to form a channel 412. Sides 404 and 408 can be considered as one side with gap 414 between them. Similarly, sides 406 and 410 can be considered as another side with gap 416 between them. A first top 418 covers a first section 420 of the channel 412. Similarly, a second top 422 covers a second section 424 of the channel 412. The first and second covered channel sections 420 and 424 are sized and spaced apart so that each covered channel 420 and 424 can receive both removable swing arms 102 (FIGS. 1A and 1B). Backbone 400 also has mounting tabs 426 that extend out from the four bottom corners of the backbone 400. Mounting holes 428 extend through the mounting tabs 426.

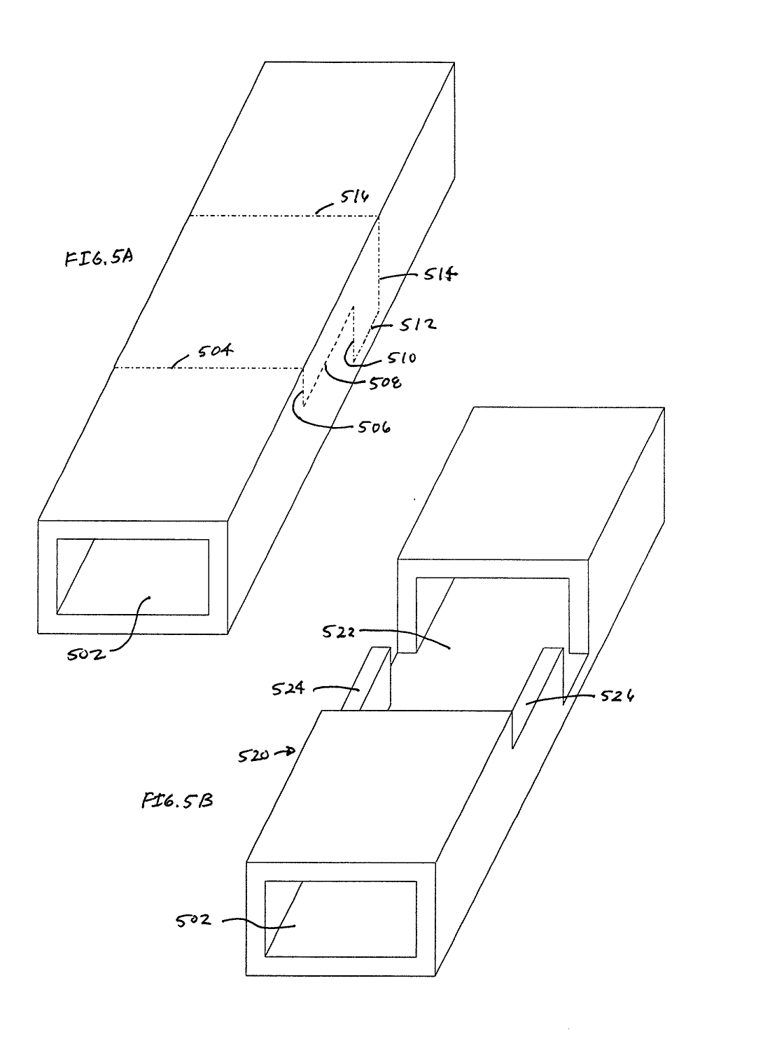

Referring now to FIGS. 5A and 5B, perspective views of a backbone before 500 and after 520 the formation of a cutout 520 in accordance with another embodiment of the present invention. Backbones 500 and 510 are substantially rectangular blocks having a substantially rectangular opening 502 extending longitudinally through the backbone 500. Backbone 510 is created by cutting backbone 500 along lines 504, 506, 508, 510, 512, 514 and 516. This forms the cutout 522 in backbone 520 to accommodate removable swing arms 102 (FIGS. 1A and 1B). Note that changing the locations of cuts 506 and 508 can vary the height of walls 524 and 526. This method provides a simple and inexpensive way of creating a modifiable backbone. Any of the mounting methods previously described can be incorporated into backbone 520.

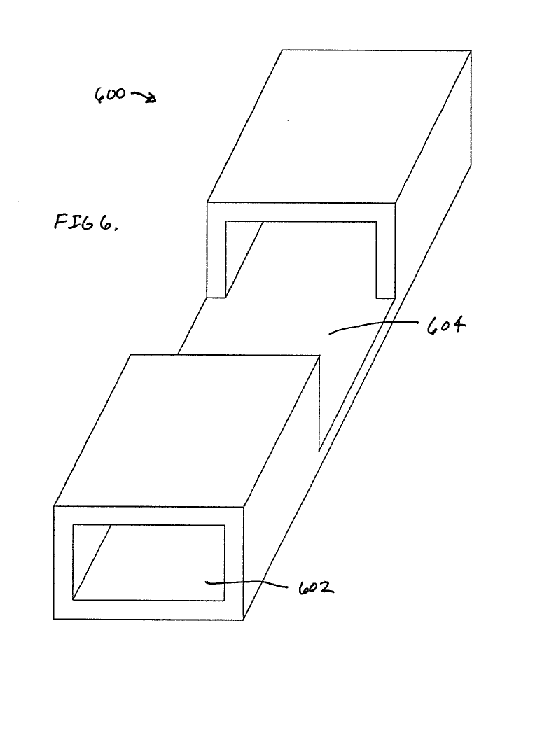

Now referring to FIG. 6, a perspective view of a backbone 600 in accordance with another embodiment of the present invention. As in FIG. 5, Backbone 600 is a substantially rectangular block having a substantially rectangular opening 602 extending longitudinally through the backbone 600. A cutout 604 is formed to accommodate removable swing arms 102 (FIGS. 1A and 1B).

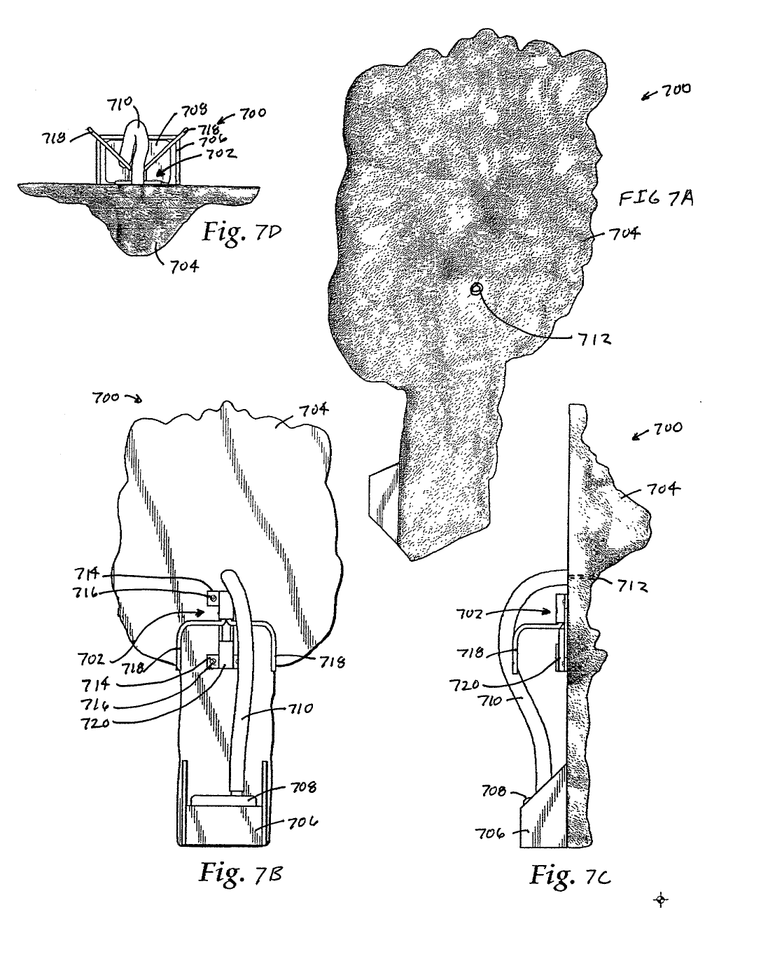

Referring now to FIGS. 7A, 7B, 7C and 7D, front perspective, back, side and top views, respectively, of a container fountain 700 having a modifiable backbone 702 in accordance with one embodiment of the present invention are shown. The container fountain also includes a decorative faceplate 704, a pump bracket 706, a pump 708 and a tube 710. The pump bracket 706 is attached to the bottom backside of the decorative faceplate 704 and holds the pump 708 in position. The decorative faceplate 704 also has a hole 712 extending through it that is connected to the pump 708 via the tube 710. Pump 708 pumps water or fluid is into the tube 710 and out the hole 712 to create the fountain effect. The modifiable backbone 702 is mounted to the backside of the decorative faceplate 704 using mounting tabs 714 and screws 716. The container fountain 700 is then attached to a container (not shown) using the removable swing arms 718 and backbone 720. Details of the backbone 720 correspond to backbone 400 illustrated in FIGS. 4A, 4B and 4C.

FIG. 8A is an exploded side view of a container 800, a container fountain 802 and a modifiable backbone 804 in accordance with the present invention showing height adjustability. Details of the container fountain 802 correspond to the container fountain of FIGS. 7A through 7D. The modifiable backbone 804 includes removable swing arms 806 and backbone 808. Details of the backbone 808 correspond to backbone 400 illustrated in FIGS. 4A, 4B and 4C. The height adjustability of the present invention is shown by the difference between removable swing arms 806 and 806a, and by dimension lines 810. Similarly, FIG. 8B is a top view of a portion of a container 800, a container fountain 802 and a modifiable backbone 804 in accordance with the present invention showing angle adjustability. The angle adjustability of the present invention is shown by the difference between removable swing arms 806 and 806b, and by arc lines 812.

While the present invention has been described in reference to illustrative embodiments, this description is not intended to be construed in a limiting sense. Various modifications and combinations of the illustrative embodiments, as well as other embodiments of the invention, will be apparent to persons skilled in the art upon reference to the description. The principles of the present invention are practicable in a number of applications and technologies.

What is claimed is:

1. A modifiable backbone comprising:
a pair of removable swing arms; and
a backbone comprising a bottom, two sides extending outward from the bottom to form a channel, a first top covering a first section of the channel, a second top covering a second section of the channel, the first covered channel section and second covered channel section sized and spaced apart so that each covered channel can receive both removable swing arms.

2. The modifiable backbone as recited in claim 1 further comprising two or more mounting tabs attached to the bottom of the backbone.

3. The modifiable backbone as recited in claim 1 further comprising two or more mounting holes extending through the bottom of the backbone.

4. The modifiable backbone as recited in claim 1 further comprising a gap in each side of the backbone between the first covered channel section and the second covered channel section to allow both swing arms to rotate to a position substantially parallel to the bottom of the backbone.

5. The modifiable backbone as recited in claim 1 wherein each swing arm comprises:
a first arm section for insertion into the first or second covered channel section;
a second arm section disposed between the first arm section and a third arm section, the second arm section extending away from the backbone when the first arm section is inserted into the first or second covered channel section; and
the third arm section extending away from and approximately parallel to the first arm section.

6. The modifiable backbone as recited in claim 1 wherein the removable swing arms are free to rotate about the axis of the backbone when the swing arms are engaged with the first enclosed channel section or the second enclosed channel section.

7. The modifiable backbone as recited in claim 1 wherein each removable swing arm is a semi-rigid shaped wire.

8. The modifiable backbone as recited in claim 1 wherein each removable swing arm is a semi-rigid shaped rod.

9. A modifiable backbone comprising:
a pair of removable swing arms; and
a backbone comprising a substantially rectangular block having a cutout disposed between a first section and a second section, the first and second sections having one or more longitudinal openings to receive the removable swing arms.

10. The modifiable backbone as recited in claim 9 wherein the one or more longitudinal openings extend through the first and second sections.

11. The modifiable backbone as recited in claim 9 wherein the one or more longitudinal openings comprise two parallel holes, each hole sized to receive one of the removable swing arms.

12. The modifiable backbone as recited in claim 9 further comprising two or more mounting tabs attached to the backbone.

13. The modifiable backbone as recited in claim 9 further comprising two or more mounting holes extending laterally through the backbone.

14. The modifiable backbone as recited in claim 9 further comprising two side walls disposed in the cutout to form a channel extending longitudinally from the first section towards the second section.

15. The modifiable backbone as recited in claim 9 wherein each swing arm comprises:
a first arm section for insertion into the one or more longitudinal openings in the first or second sections;
a second arm section disposed between the first arm section and a third arm section, the second arm section extending away from the backbone when the first arm section is inserted into the one or more longitudinal openings in the first or second sections; and
the third arm section extending away from and approximately parallel to the first arm section.

16. The modifiable backbone as recited in claim 9 wherein the removable swing arms are free to rotate about the longitudinal axis of the backbone when the swing arms are engaged with the one or more longitudinal openings in the first or second sections.

17. The modifiable backbone as recited in claim 9 wherein each removable swing arm is a semi-rigid shaped wire.

18. The modifiable backbone as recited in claim 9 wherein each removable swing arm is a semi-rigid shaped rod.
